(19) United States
(12) Patent Application Publication
(10) Pub. No.: US 2025/0012553 A1
(43) Pub. Date: Jan. 9, 2025

(54) MEASURING DEVICE

(71) Applicant: Jesus Murillo, Saltlake, UT (US)

(72) Inventor: Jesus Murillo, Saltlake, UT (US)

(21) Appl. No.: 18/217,849

(22) Filed: Jul. 3, 2023

(51) Int. Cl. G01B 3/10; G01B 3/06

(52) U.S. Cl. CPC G01B 3/10; G01B 3/06

(57) ABSTRACT

A measurement device, including a main body to be disposed on an external surface, a tape measure movably disposed within at least a portion of an interior of the main body to move from retracted within the main body in a first position to at least partially extracted from the main body in a second position, and move from extracted from the main body in the second position to retracted within the main body in the first position, such that the tape measure measures a length of the external surface while extracted, a first folding ruler, including a first section disposed on at least a portion of a first side of the main body to measure a length of a second surface, and a second section movably disposed on at least a portion of the first section to measure the length of the second surface, and a second folding ruler, including another first section disposed on at least a portion of a second side of the main body to measure the length of the second surface, and another second section movably disposed on at least a portion of the another first section to measure the length of the second surface.

### BACKGROUND

### 1. Field

The present general inventive concept relates generally to tools, and particularly, to a measuring device.

### 2. Description of the Related Art

A measurement tool is important for providing accurate information on length, distance, and/or other applications. There are a wide variety of measurement tools, such as rulers, compasses, angle gauges, levels, and/or odometers.

In certain projects, a construction worker including a carpenter, a blacksmith, and/or a maintenance worker will need to measure certain items at a work location. The need for accuracy is often high because inaccurate measurements can cause problems in construction work. However, measuring certain items and/or locations is difficult an may require multiple tools. For example, edges, and squares on a building can be difficult to measure accurately.

Therefore, there is a need for a measuring device that can accurately measure a square and other hard to reach areas.

### SUMMARY

The present general inventive concept provides a measuring device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a measurement device, including a main body to be disposed on an external surface, a tape measure movably disposed within at least a portion of an interior of the main body to move from retracted within the main body in a first position to at least partially extracted from the main body in a second position, and move from extracted from the main body in the second position to retracted within the main body in the first position, such that the tape measure measures a length of the external surface while extracted, a first folding ruler, including a first section disposed on at least a portion of a first side of the main body to measure a length of a second surface, and a second section movably disposed on at least a portion of the first section to measure the length of the second surface, and a second folding ruler, including another first section disposed on at least a portion of a second side of the main body to measure the length of the second surface, and another second section movably disposed on at least a portion of the another first section to measure the length of the second surface.

The first folding ruler and the second folding ruler may be perpendicularly disposed with respect to the tape measure.

The second section may fold over the first section for storage.

The first section and the second section may have a saw surface disposed within a channel at a center of the first section and a center of the second section to cut at least one object.

The measurement device may further include a magnet connector removably connected within at least a portion of an interior of the main body to magnetically connect to an external object.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an elevational left side view of a measurement device, according to an exemplary embodiment of the present general inventive concept;

FIG. 1B illustrates an elevational right side of the measurement device, according to an exemplary embodiment of the present general inventive concept;

FIG. 2A illustrates an elevational rear view of the measurement device, according to an exemplary embodiment of the present general inventive concept;

FIG. 2B illustrates an elevational front view of the measurement device, according to an exemplary embodiment of the present general inventive concept; and

FIG. 3 illustrates an isometric top view of a measurement device, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Measurement Device 100
Main Body 110
Base 111
Support Container 112
Tape Measure 120
First Folding Ruler 130
First Section 131
Second Section 132
First Hinge 133
Second Folding Ruler 140
First Section 141
Second Section 142
Second Hinge 143
Retracting Switch 150
Clip 160
Magnet Connector 170
Measurement Device 200
Main Body 210
Base 211
Support Container 212
Tape Measure 220
First Folding Ruler 230
First Section 231
Second Section 232
First Hinge 233
Second Folding Ruler 240
First Section 241
Second Section 242
Second Hinge 243
Retracting Switch 250
Magnet Connector 260

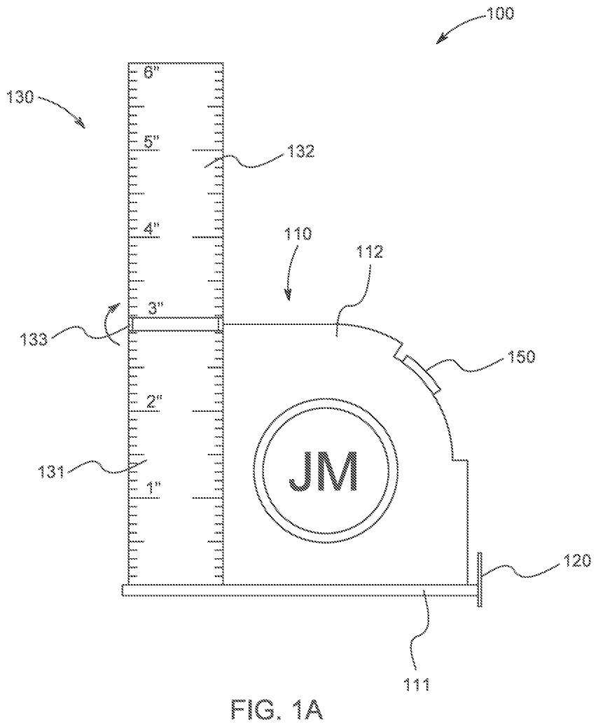

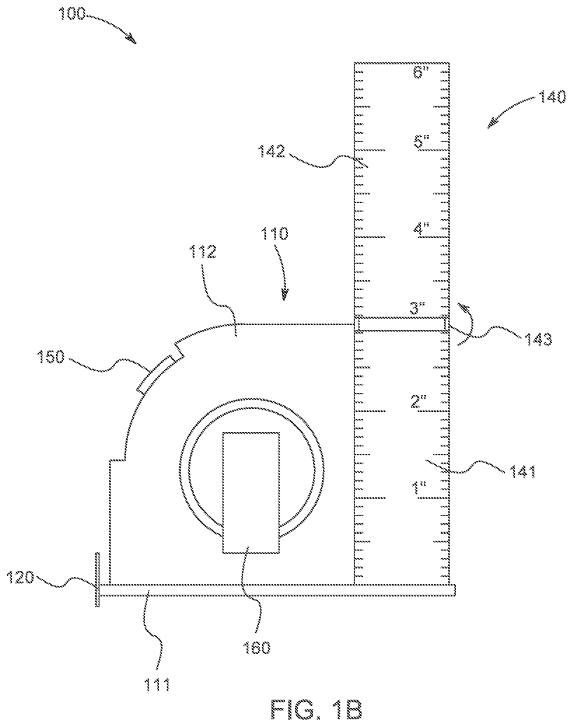

FIG. 1A illustrates an elevational left side view of a measurement device 100, according to an exemplary embodiment of the present general inventive concept.

FIG. 1B illustrates an elevational right side of the measurement device 100, according to an exemplary embodiment of the present general inventive concept.

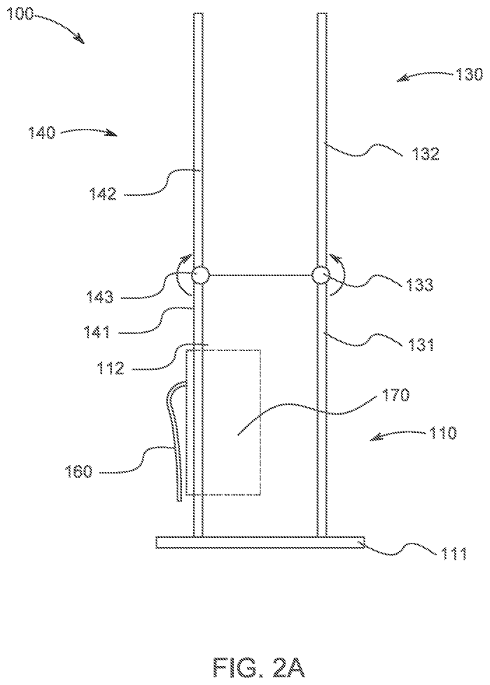

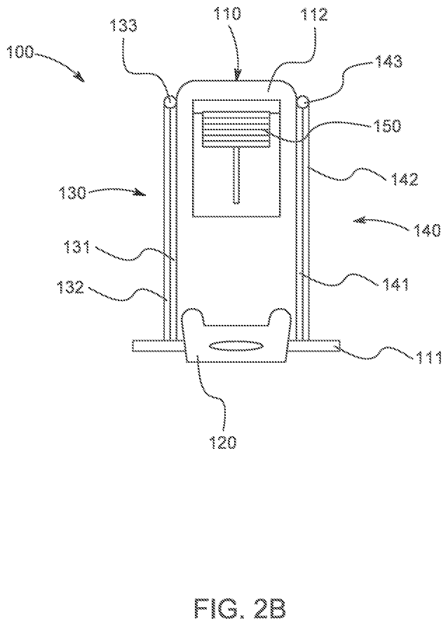

FIG. 2A illustrates an elevational rear view of the measurement device 100, according to an exemplary embodiment of the present general inventive concept.

FIG. 2B illustrates an elevational front view of the measurement device 100, according to an exemplary embodiment of the present general inventive concept.

The measurement device 100 may be constructed from at least one of metal, plastic, wood, and rubber, etc., but is not limited thereto.

Referring to FIGS. 1A through 2B, the measurement device 100 may include a main body 110, a tape measure 120, a first folding ruler 130, a second folding ruler 140, a retracting switch 150, a clip 160, and a magnet connector 170, but is not limited thereto.

The main body 110 may include a base 111 and a support container 112, but is not limited thereto.

Referring to FIGS. 1A through 2B, the base 111 is illustrated to have a rectangular prism shape. However, the base 111 may be rectangular, circular, cylindrical, triangular, pentagonal, hexagonal, heptagonal, octagonal, or any other shape known to one of ordinary skill in the art, but is not limited thereto.

The base 111 may be removably disposed on at least a portion of an external surface, such as a ground surface, a table, a desk, a countertop, a wall, a ceiling, etc. The base 111 may be planar and may be used for stability on the external surface.

The support container 112 may be disposed on at least a portion of the base 111. The support container 112 may store at least one item therein.

The tape measure 120 may be movably (i.e., springingly, rotatably, slidably) disposed within at least a portion of an interior of the support container 112. Additionally, the tape measure 120 may coil within the support container 112 during storage. The tape measure 120 may be an elongated ruler with demarcations based on at least one first predetermined distance, such as an inch, a foot, a centimeter, a millimeter, a meter, yard, etc. Additionally, the tape measure 120 may move (i.e., rotate, slide) from retracted within the support container 112 in a first position to at least partially extracted from the support container 112 in a second position. Conversely, the tape measure 120 may move from extracted from the support container 112 in the second position to retracted within the support container 112 in the first position. Thus, the tape measure 120 may measure a length of the external surface while extracted.

Thus, a length of the tape measure 120 may be adjusted based on a preference of a user, such as during measurement of an object and/or a surface. In other words, the tape measure 120 may measure a length of the object and/or a length of the surface. After use, the tape measure 120 may be moved (i.e., tugged, pulled) with a predetermined amount of force to cause the tape measure to automatically retract (e.g., via a spring) within the support container 112.

The first folding ruler 130 may include a first section 131, a second section 132, and a first hinge 133, but is not limited thereto.

The first section 131 may be disposed on at least a portion of a first side (e.g., a left side) of the support container 112. The first section 131 may be planar and/or elongate shaped. The first section 131 may be a ruler. Therefore, the first section 131 may have demarcations based on at least one second predetermined distance, such as an inch, a foot, a centimeter, a millimeter, a meter, yard, etc. As such, the first section 131 may measure the length of the object and/or the length of the surface.

The second section 132 may be movably (i.e., pivotally, rotatably) disposed on at least a portion of the first section 131. The second section 132 may be planar and/or elongate shaped. The second section 132 may be a ruler. Therefore, the second section 132 may have demarcations based on the at least one second predetermined distance. Additionally, the second section 132 may be a continuation of a measurement length from the first section 131. In other words, the second section 132 may be used to provide a continued length of measurement for longer objects and/or longer surfaces that were not possible with only the first section 131. As such, the second section 132 may measure the length of the object and/or the length of the surface.

Furthermore, the second section 132 may fold over the first section 131 during storage. The first section 131 and/or the second section 132 may be angularly (i.e., perpendicularly) disposed with respect to the tape measure 120. Also, collectively, the first section 131 and/or the second section 132 may be used with the tape measure 120 to measure a right-angled corner and/or right-angled object, such as a square.

The first hinge 133 may be movably (i.e., pivotally, rotatably) disposed between the first section 131 and/or the second section 132. The first hinge 133 may facilitate movement (i.e., rotation) of the second section 132 on the first section 131. Thus, the second section 132 may fold over the first section 131 using the first hinge 133.

The second folding ruler 140 may include a first section 141, a second section 142, and a second hinge 143, but is not limited thereto.

The first section 141 may be disposed on at least a portion of a second side (e.g., a right side) of the support container 112. The first section 141 may be planar and/or elongate shaped. The first section 141 may be a ruler. Therefore, the first section 141 may have demarcations based on at least one third predetermined distance, such as an inch, a foot, a centimeter, a millimeter, a meter, yard, etc. As such, the first section 141 may measure the length of the object and/or the length of the surface.

The second section 142 may be movably (i.e., pivotally, rotatably) disposed on at least a portion of the first section 141. The second section 142 may be planar and/or elongate shaped. The second section 142 may be a ruler. Therefore, the second section 142 may have demarcations based on the at least one third predetermined distance. Additionally, the second section 142 may be a continuation of a measurement length from the first section 141. In other words, the second section 142 may be used to provide a continued length of measurement for longer objects and/or longer surfaces that were not possible with only the first section 141. As such, the second section 142 may measure the length of the object and/or the length of the surface.

Furthermore, the second section 142 may fold over the first section 141 during storage. The first section 141 and/or the second section 142 may be angularly (i.e., perpendicularly) disposed with respect to the tape measure 120. Also, collectively, the first section 141 and/or the second section 142 may be used with the tape measure 120 to measure a right-angled corner and/or right-angled object, such as a square.

The second hinge 143 may be movably (i.e., pivotally, rotatably) disposed between the first section 141 and/or the second section 142. The second hinge 143 may facilitate movement (i.e., rotation) of the second section 142 on the first section 141. Thus, the second section 142 may fold over the first section 141 using the second hinge 143.

The retracting switch 150 may include a switch, a button, a lever, a knob, and a dial, but is not limited thereto.

The retracting switch 150 may be movably (i.e., slidably) disposed on at least a portion of the supporting container 112. The retracting switch 150 may control movement of the tape measure 120. More specifically, the tape measure 120 may be prevented (i.e., locked) from retracting within the support container 112 in response to moving (i.e., sliding) the retracting switch 150 to a first position. Conversely, the tape measure may be allowed (i.e., unlocked) to retract within the support container 112 in response to moving the retracting switch 150 to a second position.

The clip 160 may be removably connected to at least a portion of the support container 112. The clip 160 may connect the support container 112 to an external object (e.g., an article of clothing, the external surface). In other words, the clip 160 may suspend the support container 112 on the external object.

The magnet connector 170 may be removably connected within at least a portion of the interior of the support container 112. In other words, the magnet connector 170 may be inserted within an aperture on the second side of the support container 112. Moreover, the clip 160 may be disposed on at least a portion of the magnet connector 170. Thus, the magnet connector 170 may provide a magnetic connection through the clip 160 to the external object. The magnet connector 170 may magnetically connect to the interior of the support container 112.

Therefore, the measurement device 100 may be used to provide accurate measurements of a square shaped surface. Also, the measurement device 100 may be used for other applications that requires measurements at corners and/or right angles.

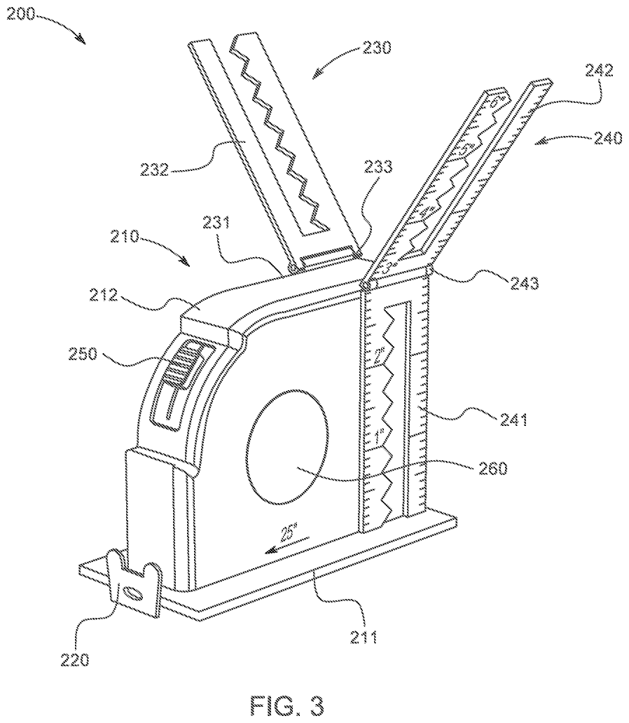

FIG. 3 illustrates an isometric top view of a measurement device 200, according to another exemplary embodiment of the present general inventive concept.

The measurement device 200 may be constructed from at least one of metal, plastic, wood, and rubber, etc., but is not limited thereto.

The measurement device 200 may include a main body 210, a tape measure 220, a first folding ruler 230, a second folding ruler 240, and a retracting switch 250, and a magnet connector 260, but is not limited thereto.

The main body 210 may include a base 211 and a support container 212, but is not limited thereto.

Referring to FIG. 3, the base 211 is illustrated to have a rectangular prism shape. However, the base 211 may be rectangular, circular, cylindrical, triangular, pentagonal, hexagonal, heptagonal, octagonal, or any other shape known to one of ordinary skill in the art, but is not limited thereto.

The base 211 may be removably disposed on at least a portion of an external surface, such as a ground surface, a table, a desk, a countertop, a wall, a ceiling, etc. The base 211 may be planar and may be used for stability on the external surface.

The support container 212 may be disposed on at least a portion of the base 211. The support container 212 may store at least one item therein.

The tape measure 220 may be movably (i.e., springingly, rotatably, slidably) disposed within at least a portion of an interior of the support container 212. Additionally, the tape measure 220 may coil within the support container 212 during storage. The tape measure 220 may be an elongated ruler with demarcations based on at least one first predetermined distance, such as an inch, a foot, a centimeter, a millimeter, a meter, yard, etc. Additionally, the tape measure 220 may move (i.e., rotate, slide) from retracted within the support container 212 in a first position to at least partially extracted from the support container 212 in a second position. Conversely, the tape measure 220 may move from extracted from the support container 212 in the second position to retracted within the support container 212 in the first position. Thus, the tape measure 220 may measure a length of the external surface while extracted.

Thus, a length of the tape measure 220 may be adjusted based on a preference of a user, such as during measurement of an object and/or a surface. In other words, the tape measure 220 may measure a length of the object and/or a length of the surface. After use, the tape measure 220 may be moved (i.e., tugged, pulled) with a predetermined amount of force to cause the tape measure to automatically retract (e.g., via a spring) within the support container 212.

The first folding ruler 230 may include a first section 231, a second section 232, and a first hinge 233, but is not limited thereto.

The first section 231 may be disposed on at least a portion of a first side (e.g., a left side) of the support container 212. The first section 231 may be planar and/or elongate shaped. The first section 231 may be a ruler. Therefore, the first section 231 may have demarcations based on at least one second predetermined distance, such as an inch, a foot, a centimeter, a millimeter, a meter, yard, etc. As such, the first section 231 may measure the length of the object and/or the length of the surface.

The second section 232 may be movably (i.e., pivotally, rotatably) disposed on at least a portion of the first section 231. The second section 232 may be planar and/or elongate shaped. The second section 232 may be a ruler. Therefore, the second section 232 may have demarcations based on the at least one second predetermined distance. Additionally, the second section 232 may be a continuation of a measurement length from the first section 231. In other words, the second section 232 may be used to provide a continued length of measurement for longer objects and/or longer surfaces that were not possible with only the first section 231. As such, the second section 232 may measure the length of the object and/or the length of the surface.

Moreover, the first section 231 and/or the second section 232 may have a channel at a center thereof. The first section 231 and/or the second section 232 may have jagged (i.e., zig zag) portion similar to teeth to provide a saw surface for cutting at least one object.

Furthermore, the second section 232 may fold over the first section 231 during storage. The first section 231 and/or the second section 232 may be angularly (i.e., perpendicularly) disposed with respect to the tape measure 220. Also, collectively, the first section 231 and/or the second section 232 may be used with the tape measure 220 to measure a right-angled corner and/or right-angled object, such as a square.

The first hinge 233 may be movably (i.e., pivotally, rotatably) disposed between the first section 231 and/or the second section 232. The first hinge 233 may facilitate movement (i.e., rotation) of the second section 232 on the first section 231. Thus, the second section 232 may fold over the first section 231 using the first hinge 233.

The second folding ruler 240 may include a first section 241, a second section 242, and a second hinge 243, but is not limited thereto.

The first section 241 may be disposed on at least a portion of a second side (e.g., a right side) of the support container 212. The first section 241 may be planar and/or elongate shaped. The first section 241 may be a ruler. Therefore, the first section 241 may have demarcations based on at least one third predetermined distance, such as an inch, a foot, a centimeter, a millimeter, a meter, yard, etc. As such, the first section 241 may measure the length of the object and/or the length of the surface.

The second section 242 may be movably (i.e., pivotally, rotatably) disposed on at least a portion of the first section 241. The second section 242 may be planar and/or elongate shaped. The second section 242 may be a ruler. Therefore, the second section 242 may have demarcations based on the at least one third predetermined distance. Additionally, the second section 242 may be a continuation of a measurement length from the first section 241. In other words, the second section 242 may be used to provide a continued length of measurement for longer objects and/or longer surfaces that were not possible with only the first section 241. As such, the second section 242 may measure the length of the object and/or the length of the surface.

Moreover, the first section 241 and/or the second section 242 may have a channel at a center thereof. The first section 241 and/or the second section 242 may have jagged (i.e., zig zag) portion similar to teeth to provide a saw surface for cutting at least one object.

Furthermore, the second section 242 may fold over the first section 241 during storage. The first section 241 and/or the second section 242 may be angularly (i.e., perpendicularly) disposed with respect to the tape measure 220. Also, collectively, the first section 241 and/or the second section 242 may be used with the tape measure 220 to measure a right-angled corner and/or right-angled object, such as a square.

The second hinge 243 may be movably (i.e., pivotally, rotatably) disposed between the first section 241 and/or the second section 242. The second hinge 243 may facilitate movement (i.e., rotation) of the second section 242 on the first section 241. Thus, the second section 242 may fold over the first section 241 using the second hinge 243.

The retracting switch 250 may include a switch, a button, a lever, a knob, and a dial, but is not limited thereto.

The retracting switch 250 may be movably (i.e., slidably) disposed on at least a portion of the supporting container 212. The retracting switch 250 may control movement of the tape measure 220. More specifically, the tape measure 220 may be prevented (i.e., locked) from retracting within the support container 212 in response to moving (i.e., sliding) the retracting switch 250 to a first position. Conversely, the tape measure may be allowed (i.e., unlocked) to retract within the support container 212 in response to moving the retracting switch 250 to a second position.

The magnet connector 260 may be removably connected within at least a portion of the interior of the support container 212. In other words, the magnet connector 270 may be inserted within an aperture on the second side of the support container 212. Thus, the magnet connector 260 may provide a magnetic connection to the external object. The magnet connector 260 may magnetically connect to the interior of the support container 212.

Therefore, the measurement device 200 may be used to provide accurate measurements of a square shaped surface. Also, the measurement device 200 may be used for other applications that requires measurements at corners and/or right angles.

The present general inventive concept may include a measurement device 100, including a main body 110 to be disposed on an external surface, a tape measure 120 movably disposed within at least a portion of an interior of the main body 110 to move from retracted within the main body 110 in a first position to at least partially extracted from the main body 110 in a second position, and move from extracted from the main body 110 in the second position to retracted within the main body 110 in the first position, such that the tape measure 120 measures a length of the external surface while extracted, a first folding ruler 130, including a first section 131 disposed on at least a portion of a first side of the main body 110 to measure a length of a second surface, and a second section 132 movably disposed on at least a portion of the first section 131 to measure the length of the second surface, and a second folding ruler 140, including another first section 141 disposed on at least a portion of a second side of the main body 110 to measure the length of the second surface, and another second section 142 movably disposed on at least a portion of the another first section 141 to measure the length of the second surface.

The first folding ruler 130 and the second folding ruler 140 may be perpendicularly disposed with respect to the tape measure 120.

The second section 132 may fold over the first section 131 for storage.

The first section 231 and the second section 232 may have a saw surface disposed within a channel at a center of the first section 231 and a center of the second section 232 to cut at least one object.

The measurement device 100 may further include a magnet connector 170 removably connected within at least a portion of an interior of the main body 110 to magnetically connect to an external object.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A measurement device, comprising:
a main body to be disposed on an external surface;
a tape measure movably disposed within at least a portion of an interior of the main body to move from retracted within the main body in a first position to at least partially extracted from the main body in a second position, and move from extracted from the main body in the second position to retracted within the main body in the first position, such that the tape measure measures a length of the external surface while extracted;
a first folding ruler, comprising:
a first section disposed on at least a portion of a first side of the main body to measure a length of a second surface, and
a second section movably disposed on at least a portion of the first section to measure the length of the second surface; and
a second folding ruler, comprising:
another first section disposed on at least a portion of a second side of the main body to measure the length of the second surface, and
another second section movably disposed on at least a portion of the another first section to measure the length of the second surface.

2. The measurement device of claim 1, wherein the first folding ruler and the second folding ruler are perpendicularly disposed with respect to the tape measure.

3. The measurement device of claim 1, wherein the second section folds over the first section for storage.

4. The measurement device of claim 1, wherein the first section and the second section have a saw surface disposed within a channel at a center of the first section and a center of the second section to cut at least one object.

5. The measurement device of claim 1, further comprising:
a magnet connector removably connected within at least a portion of an interior of the main body to magnetically connect to an external object.
